(19) United States
(12) Patent Application Publication
(10) Pub. No.: US 2025/0391237 A1
(43) Pub. Date: Dec. 25, 2025

(54) METHOD, DEVICE AND COMPUTER PROGRAM FOR IMPLEMENTING DIGITAL LINKED GAMES

(71) Applicant: FDJ GAMING SOLUTIONS FRANCE, BOULOGNE-BILLANCOURT (FR)

(72) Inventors: Antoine MAILLET, COURBEVOIE (FR); Eric MEYNIEUX, VENTABREN (FR); Cédric MARCADIER, ISSY LES MOULINEAUX (FR)

(21) Appl. No.: 18/880,550

(22) PCT Filed: Jul. 3, 2023
(86) PCT No.: PCT/FR2023/051014

§ 371 Date: Dec. 31, 2024

(30) Foreign Application Priority Data
Jul. 1, 2022 (EP) 22305992.4
Jul. 6, 2022 (FR) 2206911

(51) Int. Cl. G07F 17/32

(52) U.S. Cl. CPC G07F 17/3227; G07F 17/329

(57) ABSTRACT

A method in a system includes games devices and a server. The first device participates in the first and third games and the second device participates in second and third games. The server includes distinct software modules to implement the first, second and third games. The server further includes a linked game management software module to execute the software module linked to the third game following execution of the software module linked to the first or second game. Digital data to execute the third game is received by the linked game management software module. The digital data is received from the software module linked to the first or second game. The software module linked to the third game is updated according to the digital data received.

The invention is concerned with instant digital lottery games, participation in which may give access (for example in the event of a losing result) to participation in a second game such as an instant digital jackpot game (of the ‘1 in N chance of winning’ type), and with the implementation of such linked games on computer servers. In the remainder of this text, it will be said that the digital lottery game and the digital jackpot game to which it gives access are linked games.

The object of the present invention is to simplify development and implementation of digital linked games, especially instant digital lottery games and instant digital jackpot games. The invention further enables the implementation of multi-jurisdictional jackpot games, i.e. jackpots linked to games belonging to multi-jurisdictional lotteries.

### DISCLOSURE OF THE INVENTION

To that end, the invention provides a method, a device and a computer program for implementing linked games.

Thus provided is a digital linked games management method for a games system comprising a plurality of games devices and at least one server, wherein a first games device is configured to participate in a first and a third game and a second games device is configured to participate in a second and the third game, the first, second and third games being different, said at least one server comprising a first software module implementing said first game, a second software module implementing said second game and a third software module implementing said third game, said first, second and third software modules being distinct, said at least one server further comprising a linked game management software module, said linked game management software module being configured to execute said third software module following execution of said first software module and to execute said third software module following execution of said second software module, the method being implemented in said at least one server comprising at least one processor and comprising the steps of:
receiving, by said linked game management software module, digital data for executing said third game, said digital data being received from said first and second software modules, and
updating said third software module according to the digital data received.

The method according to the invention thus makes it possible to implement digital linked games in a complex environment, especially in a multi-jurisdictional context, and to simplify and reduce the costs of developing and implementing digital linked games.

According to particular embodiments, the method further comprises a step of adapting at least one digital piece of data received according to a normalization coefficient linked to said first or second games device.

Still according to particular embodiments, said adapting comprises converting said at least one piece of data received into a unit specific to said at least one third software module.

Again according to particular embodiments, the method further comprises a step of executing said third software module and generating a digital result.

Still according to particular embodiments, the method further comprises a step of adapting said digital result according to an adaptation coefficient linked to said first or second games device.

Again according to particular embodiments, received digital data are common to users of said first and second software modules and received digital data are specific to users of said first software module or said second software module.

Again according to particular embodiments, a generated result specific to a user of said first software module is based on said common data and, if there are data specific to said users of said first software module, on said data specific to said users of said first software module.

Still according to particular embodiments, the method further comprises a step of transmitting said result to said first or second games device.

Still according to particular embodiments, said first and second games are digital lottery games and said second game is a digital jackpot game.

Another object of the invention is a device comprising a processing unit configured to execute each of the steps of the method previously described. The advantages of this device are similar to those of the method previously described.

The present invention is also directed to a computer program including instructions for implementing the method described above, or some parts of this method, when this program is executed by a computer.

This program may use any programming language (for example, an object language or other), and be in the form of an interpretable source code, a partially compiled code or a fully compiled code.

Another aspect relates to a non-transitory computer executable program storage medium comprising a set of data representing one or more programs, said one or more programs comprising instructions for, upon executing said one or more programs by a computer comprising a processing unit operatively coupled to memory means and an input/output interface module, executing all or part of the method described above.

### BRIEF DESCRIPTION OF THE DRAWINGS

Further characteristics, details and advantages of the invention will become apparent upon reading the following description. This description is purely illustrative and should be read with regard to the appended drawings wherein:

FIG. 1 illustrates an example of an environment wherein the invention may be implemented according to particular embodiments;

FIG. 2 illustrates an example of a graphical interface used on a player's device to play linked games, in this case an instant digital lottery game and then an instant digital jackpot game;

FIG. 3 illustrates a first example of the software architecture of a linked games system, according to the embodiments of the invention, enabling a player to participate in a first game and, after having participated in the first game, in a second game.

FIG. 4 illustrates an example of communication between application modules, an instant game module, a linked game management module and a jackpot game management module such as those illustrated in FIG. 3;

FIG. 5 illustrates a second example of the software architecture of a linked games system, according to the embodiments of the invention, enabling a player to participate in a first game and, after participating in the first game, in a second game;

FIG. 6 illustrates a third example of the software architecture of a linked games system, according to the embodiments of the invention, enabling a player to participate in a first game and, after having participated in the first game, in a second game;

FIG. 7 illustrates a first example of the implementation of two linked games comprising distinct instant games and a common jackpot game;

FIG. 8 illustrates a second example of the implementation of two linked games comprising distinct instant games and a common jackpot game;

FIG. 9 illustrates a third example of the implementation of two linked games comprising distinct instant games and a common jackpot game; and

FIG. 10 illustrates an example of device that can be used to implement, at least partially, embodiments of the invention, in particular steps described with reference to FIGS. 2 to 9.

### DETAILED DESCRIPTION

According to particular embodiments of the invention, the software architecture used to implement linked games is organized into software modules enabling different linked games to be based on common modules. Furthermore, this architecture allows the use of common modules for linked games implemented in particular contexts, for example games implemented in distinct jurisdictions, with different currencies for example. Linked games are, for example, instant digital lottery games and instant digital jackpot games. A same jackpot game can thus be linked to different lottery games, thereby reducing development time and costs. Sharing a same jackpot game with several lottery games further increases the amount of winnings.

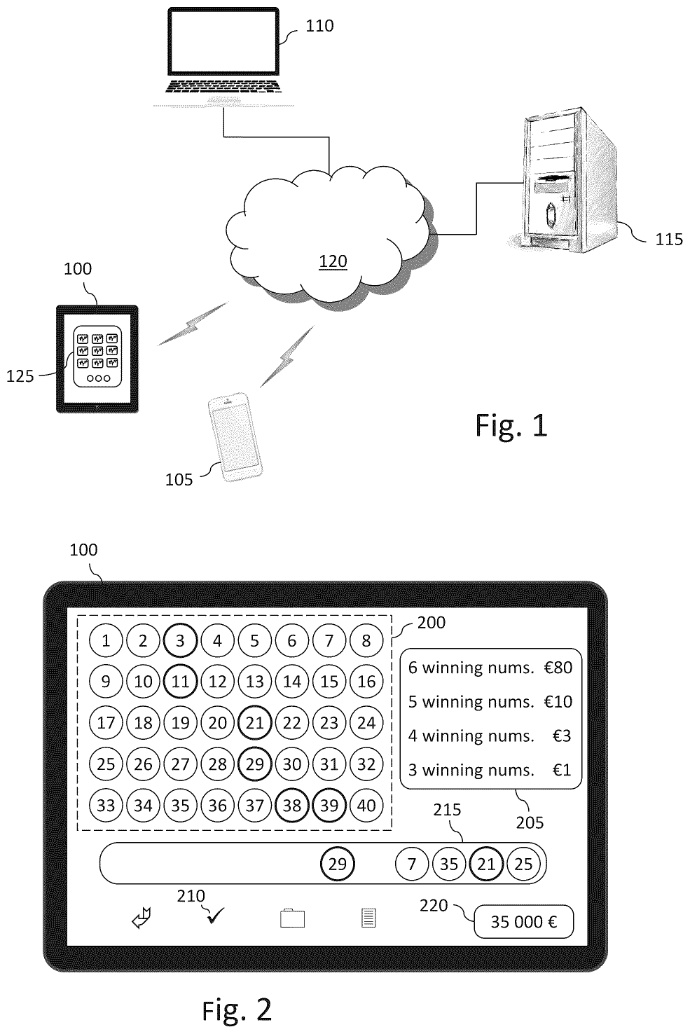

FIG. 1 illustrates an example of an environment wherein the invention may be implemented according to particular embodiments. According to this example, a user can access linked games using a personal games device or a self-service games device, for example using a tablet 100, smartphone 105 or computer 110. This access can especially be made after the player has connected to a previously created player account. Such a player account can especially be used to purchase a participation in an instant digital lottery game. Some instant digital lottery games offer the right to participate in an instant digital jackpot game. In this case, according to one of the embodiments, a portion of the stake in the instant digital game is taken to contribute to the jackpot in question, and following participation in the instant digital game, an instant jackpot draw is made for the player. The draw is generally of the “1 chance to win from N” type. The instant digital lottery game and the instant digital jackpot game to which it gives access will be referred to as linked games.

Access to these games is provided by a game operator on a server 115, via a communications network 120.

By way of example, the lottery game may be accessed via a graphical interface, for example the interface 125, which may be a web interface or an interface of an application (app) installed on the player's device and configured to interface with the corresponding game application implemented on the server 115.

The communication network 120 is, for example, the Internet network to which the devices 100, 105, 110 and 115 can connect using standard wired or wireless communication technologies, using known communication protocols.

It is noticed that the linked games can be implemented on a single server 115 or on several servers, for example in the form of software modules specific to each game. For example, lottery games can be implemented through software modules installed on a first server and the jackpot game can be implemented through a software module installed on another server. Lottery games can also be implemented through software modules installed on different servers.

In the same way, lottery games and jackpot games can be implemented by distinct game operators. Thus, for example, a first lottery game and associated jackpot game may be implemented on a first server and provided by a first gaming operator and a second lottery game may be implemented on a second server and associated with the jackpot game implemented on the first server, the second lottery game and associated jackpot game being provided by a second gaming operator.

FIG. 2 illustrates an example of a graphical interface used on a player's games device, for example the tablet 100 of FIG. 1, to participate in linked games, in this case an instant digital lottery game and then an instant digital jackpot game.

As illustrated, the graphical interface comprises a first zone 200 enabling a user to select several numbers, for example six numbers between one and forty. The numbers selected are those surrounded by a thicker line. The graphical interface also comprises a second zone 205 in which potential winnings are displayed and a validation button 210 enabling the selected numbers to be validated and thus validating purchase of the linked games comprising participation in the lottery game for which a player has just selected the numbers played and participation in a jackpot game. As soon as validation is complete, an instant draw is made. According to the example illustrated, six numbers between one and forty are drawn and displayed one after the other in a results window 215 (only the first five numbers are drawn here, from which two have been selected by the player who is thus likely to win €1 if the last number drawn is a number played). Once the player has participated in the lottery game, they are provided with the opportunity to participate in the jackpot game. Alternatively, they can participate in it automatically once they have played the lottery game. As illustrated, the jackpot amount associated with the lottery game in which the player is participating is displayed in the display zone 220. It is preferably automatically updated.

The game engines corresponding to the lottery game and the jackpot game are, for example, implemented in the server 115 of FIG. 1.

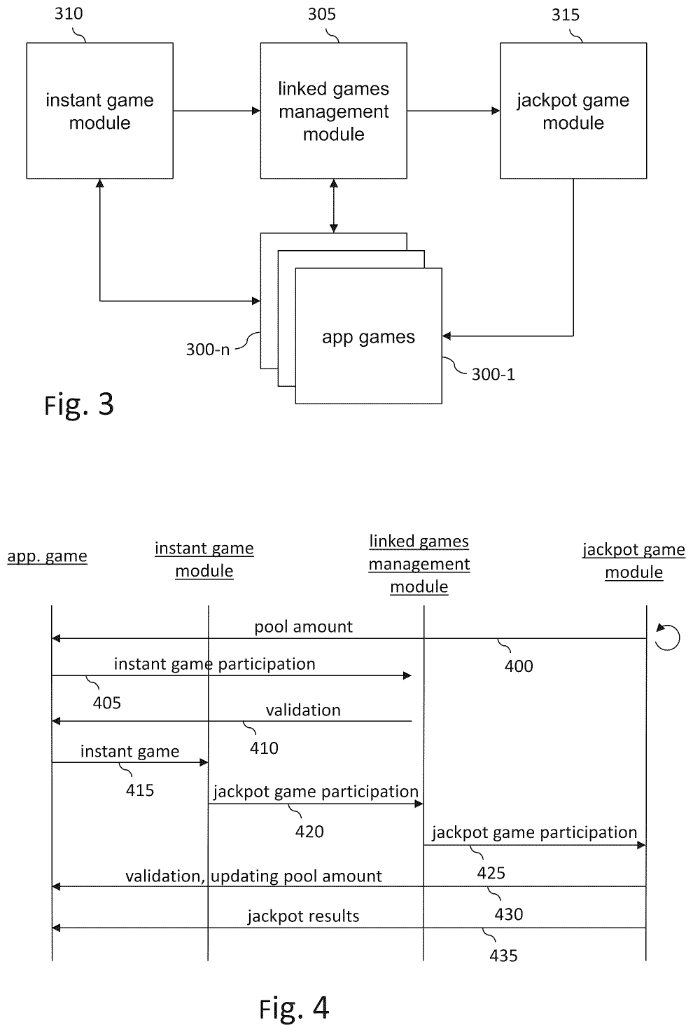

FIG. 3 illustrates a first example of the software architecture of a linked games system, according to the embodiments of the invention, enabling a player to participate in a first game and, after having participated in the first game, in a second game.

As illustrated, the game system here comprises several software modules, especially application or app modules 300-1 to 300-n (generically referred to 300), to be implemented in each of the devices used by players to participate in it. They may especially comprise an interface enabling a player to interact with the games system, in particular to participate in a first game, for example a lottery game as described with reference to FIG. 2. These application modules are specific to one or more particular games, for example one or more lottery games and the jackpot games associated therewith.

The application modules 300 are connected to a linked game management module 305, the purpose of which is in particular to manage player participation in games, in particular to manage payments and distribution of these payments between the linked games (preferably transparently to the player). Another purpose thereof is to trigger participation in the second game, for example a jackpot game, after the player has participated in the first game, for example a lottery game.

The application modules 300 are also connected to a game module 310 to enable a player to participate in the first game, for example to select and validate numbers in a lottery game as described with reference to FIG. 2. This game module is referred to as an instant game module. The instant game module 310 receives the player's participation information, for example the numbers selected, and executes the corresponding game. By way of illustration, the instant game module 310 can draw numbers at random, compare them to numbers selected by a player and determine a game result. As illustrated, the instant game module 310 is also connected to the linked game management module 305, in particular to inform it of a player's participation in the game implemented by the instant game module 310 and to trigger, if necessary, participation in the second game.

The application modules 300 are also connected to a game module 315 to enable a player to participate in the second game, for example to allow the player to receive an amount from a jackpot game pool and, if applicable, an amount of winnings. This game module is referred to as a jackpot game module. The jackpot game module 315 can manage player participation in a jackpot game as well as the pool. Different rules may be used to manage the pool according to the player participations, for example progressively (the amount of the pool increases proportionally to the amount of participations), incrementally (the amount of the pool increases incrementally according to the amount of participations), or fixedly (the amount is fixed and determined), etc. As illustrated, the jackpot game module 315 is also connected to the linked game management module 305, in particular to enable the linked game management module 305 to trigger a player to participate in the second game.

The links between modules 300, 305, 310 and 315 are links for exchanging data and triggering participation in a game. They can use standard communication protocols.

FIG. 4 illustrates an example of communication between application modules, an instant game module, a linked game management module and a jackpot game management module, such as the software modules illustrated in FIG. 3.

The purpose of a first step (step 400) is to transmit information relating to a second game, for example a jackpot game pool amount, between a jackpot game module, for example the jackpot game module 315 of FIG. 3, and application modules, for example the application modules 300 of FIG. 1. As illustrated, this step is repeated, for example as soon as the amount in the pool changes or the variation exceeds a particular threshold.

In a next step, after a player has validated a participation in a first game linked to a second game of which information may have been received, for example a lottery game as described with reference to FIG. 2, a request to participate in the first game is transmitted (step 405) from the application module implemented in the device used by the player to a linked game management module, for example the linked game management module 305 of FIG. 3. This request preferably comprises information about the player, especially information enabling them to be debited with an amount corresponding to their participation in the linked games. According to particular embodiments, in response to reception of a participation request, the linked game management module obtains the player's payment (directly or via a third party) and allocates part of it to the instant game and part to the jackpot game according to predetermined rules stored in the module itself or to which it has access. The amount of the participation in can be transmitted in the request or can be known to the linked games management module. After obtaining payment from the player, the linked game management module sends information validating participation in the first game to the application module implemented in the games device used by the player (step 410).

After receiving information validating participation in the first game, the application module implemented in the device used by the player sends a participation request to a game module enabling the first game to be implemented, for example the instant game module 310 of FIG. 3 (step 415). This request preferably comprises the game parameters, for example numbers selected by the player to participate in the game. The game module used to implement the first game then executes the game. By way of illustration, the game module enabling the first game to be implemented carries out a draw and compares the result of this draw with a selection made by the player to participate in the game.

In a next step, the game module enabling implementation of the first game sends information to the linked game management module to inform it of the player's participation in the first game (step 420). In response, the linked game management module sends a request to the jackpot game module to request the player's participation in the jackpot game (step 425). This request comprises, for example, an indication relating to the player's identity and a participation amount. Upon reception of this request, the jackpot game module registers the player's participation in the game and updates the amount of the pool. As previously indicated, the updated pool amount is preferably sent to the application modules (step 430). When the jackpot game module performs the draw, for example on the basis of predetermined rules (for example on a predetermined date), it informs the winner(s) or all the players who participated in the jackpot (step 435).

As described previously, the instant game module, the game management module and the jackpot game module can be implemented on a single server or on multiple servers. According to the configuration, communication between these modules is carried out within the same server or via a communication network, for example using standard communication protocols.

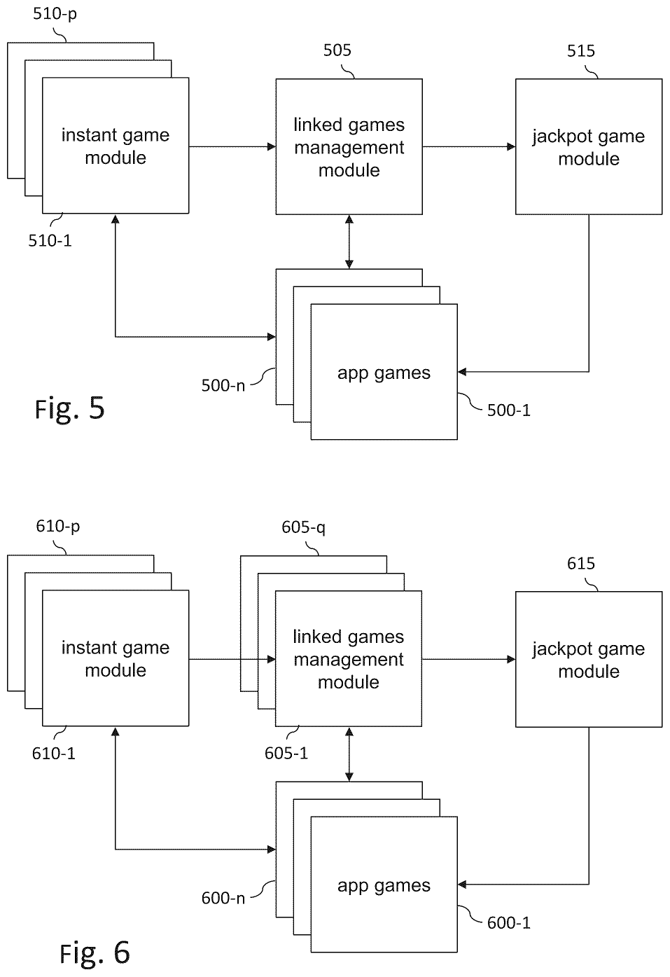

FIG. 5 illustrates a second example of the software architecture of a linked games system, according to the embodiments of the invention, enabling a player to participate in a first game and, after participating in the first game, in a second game.

According to this example, several different first games, for example several different first instant games, can be associated with the same second game, for example a same jackpot game.

Again, as illustrated, the games system here comprises application or app modules 500-1 to 500-n (generically referred to as 500), to be implemented in each of the devices used by players to participate in it. In particular, they comprise an interface enabling a player to interact with the games system, in particular to participate in the first game, for example a lottery game as described with reference to FIG. 2. These application modules are specific to one or more particular games, for example one or more lottery games and the jackpot games associated therewith.

The application modules (500) are linked to a linked game management module (505), the purpose of which is especially to manage player participation in games, especially to manage payments and the distribution of these payments between the linked games (transparently for the player). Another purpose thereof is to trigger participation in the second game, for example a jackpot game, after the player has participated in a first game, for example a lottery game.

The application modules 500 are also connected to one or more game modules 510-1 to 510-p, preferably independent of one another, generically referenced 510, to enable a player to participate in a first game of their choice from among the first games provided by the application module installed on the device they are using, for example selecting and validating numbers in a lottery game as described with reference to FIG. 2. The instant game module selected receives the player's participation information, for example the numbers selected, and runs the corresponding game. Again, the instant game modules 510 are linked to the linked game management module 505, in particular to inform it of a player's participation in a game implemented by an instant game module 510 and to trigger, if necessary, participation in the second game.

The application modules 500 are also connected to a game module 515 to enable a player to participate in the second game, for example to enable the player to receive an amount from a jackpot game pool and, if applicable, an amount of winnings. Like the jackpot game module 315, the jackpot game module 515 can manage player participation in a jackpot game as well as the pool. Likewise, the jackpot game module 515 is also connected to the linked game management module 505, in particular to enable the linked game management module 505 to trigger a player to participate in the second game.

FIG. 6 illustrates a third example of the software architecture of a linked games system, according to the embodiments of the invention, enabling a player to participate in a first game and, after having participated in the first game, in a second game.

According to this example, several different first games, for example several different first instant games, can be associated with the same second game, for example a same jackpot game. As illustrated, this software architecture implements several linked game management modules, thus making it easy to implement games in different locations with different legislation and/or currencies.

Again, as illustrated, the game system here comprises application or app modules 600-1 to 600-n (generically referred to as 600), to be implemented in each of the devices used by players to participate in it. In particular, they comprise an interface enabling a player to interact with the games system, in particular to participate in the first game, for example a lottery game as described with reference to FIG. 2. These application modules are specific to one or more particular games, for example one or more lottery games and the jackpot games associated therewith.

Each of the application modules 600 is connected to a linked game management module from among the linked game management modules 605-1 to 605-q, generically referred to as 605, identified according to the application module used, for example on the basis of a geographical location of the device implementing the application module in question or according to a player registration place. The purpose of each of the modules for managing linked games is especially to manage player participation, in particular to manage payments and distribution of these payments between the linked games (transparently for the player). Another purpose thereof is to trigger participation in the second game, for example a jackpot game, after the player has participated in a first game, for example a lottery game. Each of the linked game management modules can further be configured to perform conversions, for example converting participation in the second game from a local currency to a reference unit used by the second game and vice versa, as described below.

The application modules 600 are also connected to one or more game modules 610-1 to 610-p, preferably independent of one another, generically referenced 610, to enable a player to participate in a first game of their choice from among the first games provided by the application module installed on the device they are using, for example selecting and validating numbers in a lottery game as described with reference to FIG. 2. The instant game module selected receives the player's participation information, for example the numbers selected, and runs the corresponding game. Again, the instant game modules 610 are connected to a linked game management module 605, in particular to inform it of a player's participation in a game implemented by an instant game module 610 and to trigger, if necessary, participation in the second game.

The application modules 600 are also connected to a game module 615 to enable a player to participate in the second game, for example to enable the player to receive an amount from a jackpot game pool and, if applicable, an amount of winnings. Like the jackpot game module 315, the jackpot game module 615 can manage player participation in a jackpot game as well as the pool. Similarly, the jackpot game module 615 is also connected to a linked game management module 605, in particular to enable the linked game management module 605 to trigger a player to participate in the second game.

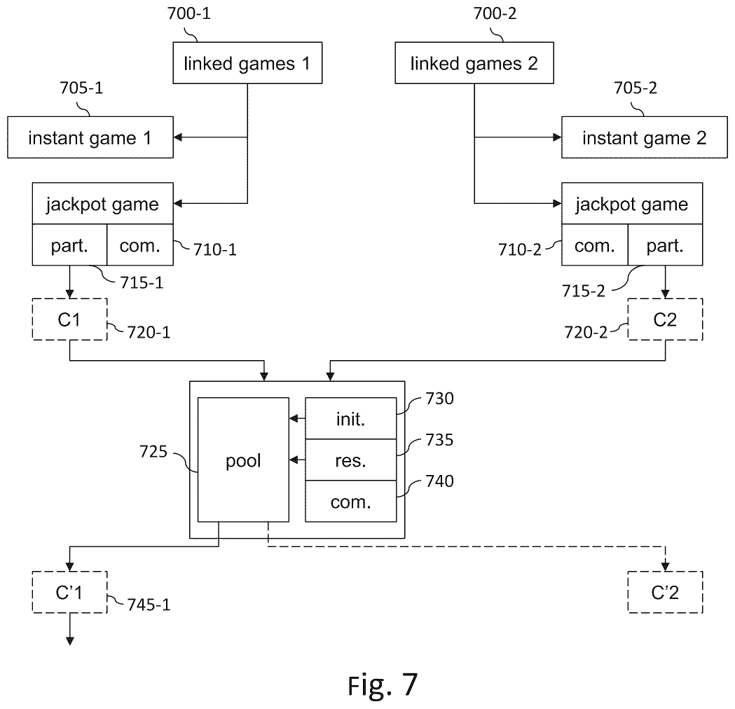

FIG. 7 illustrates a first example of the implementation of two linked games comprising distinct instant games and a common jackpot game.

As illustrated, participation in a first set of linked games, for example via a single purchase of a first amount referenced 700-1, here enables participation in a first instant game for a first fraction of the amount of the first set of linked games, referenced 705-1, and participation in a jackpot game for a second fraction of the amount of the first set of linked games. This second fraction can itself be broken down into a commission for the gaming operator managing the first set of linked games, referenced 710-1, and a second part being the subject of the jackpot game, managed by the same gaming operator or by another, referenced 715-2.

According to particular embodiments, the second part being the subject of the jackpot game is converted into game units, for example into tokens, according to a fixed or variable conversion coefficient or rate, referenced 720-1. For example, if players using different currencies can participate in the same jackpot game, a reference coefficient can be defined for one of the currencies referred to as the reference currency (e.g. twenty tokens correspond to one euro) and estimated rates, based for example on historical exchange rates, including a risk margin, can be used for the other currencies. The price of the game units or tokens is thus predetermined for all players.

The second part being the subject of the jackpot game, if necessary converted into game units or tokens, is then broken down, for example, according to predetermined ratios, for example, to feed the jackpot game pool, referenced 725, to feed an initialization fund used to create a base jackpot when a new jackpot is created after one or more players have won, referenced 730, to fund a reserve fund that can be used in case of difficulty by the jackpot game operator or to exceptionally fund the pool, referenced 735, and/or to fund the jackpot game operator in the form of a commission referenced 740.

If after the draw, a player who participated in the first set of linked games wins the jackpot, an inverse coefficient, referenced 745-1, may be applied, in particular if the second part being the subject of the jackpot game has been converted into game units or tokens. If the jackpot amount won has to be converted into the reference currency, a coefficient inverse to that used to convert the second part being the subject of the jackpot game into game units or tokens may be applied. On the other hand, if the jackpot amount won has to be converted into a currency other than the reference currency, the coefficient used may be based on the exchange rate (relative to the reference currency) on the day the jackpot is paid out, taking account of the conversion coefficient between the reference currency and the game units or tokens.

In the same way, participation in a second set of linked games, for example via a single purchase of a first amount referenced 700-2, allows participation in a second instant game, different from the first instant game, for a first fraction of the amount of the second set of linked games, referenced 705-2, and participation in the jackpot game for a second fraction of the amount of the second set of linked games. Again, this second fraction can itself be broken down into a commission for the gaming operator managing the second set of linked games, referenced 710-2, and a second part being the subject of the jackpot game, managed by the same gaming operator or by another, referenced 715-2.

Similarly, the second part being the subject of the jackpot game can be converted into game units, for example tokens, according to a fixed or variable conversion coefficient or rate, referenced 720-2. The second part being the subject of the jackpot game, if necessary converted into game units, is broken down to feed the jackpot game pool, referenced 725, to feed an initialization fund used to create a base jackpot when a new jackpot is created after one or more players have won, referenced 730, to feed a reserve fund that can be used in case of difficulty by the jackpot game operator or to exceptionally feed the pool, referenced 735, and/or to finance the jackpot game operator in the form of a commission referenced 740.

By way of illustration, the jackpot game operator may here implement a jackpot game module such as one of the jackpot game modules 515 and 615 described with reference to FIGS. 5 and 6. It can also implement a linked game management module such as one of the linked game management modules 505 and 605 described with reference to FIGS. 5 and 6. The game operators of the first and second sets of linked games can implement instant game modules such as the instant game modules 505 and 605 described with reference to FIGS. 5 and 6. They can also implement linked game management modules such as the linked game management modules 505 and 605 described with reference to FIGS. 5 and 6.

According to particular embodiments, when the game operators of the first and second sets of linked games implement linked game management modules such as the linked game management modules 505 and 605 described with reference to FIGS. 5 and 6, money transfers to the jackpot game operator are only made when the jackpot is won.

Still according to particular embodiments, the amount of the pool is calculated in the different currencies used, preferably using the exchange rate of the day, as previously described, to indicate the amount that can potentially be won by each day (as described with reference to steps 400 and 430 of FIG. 4).

Still according to particular embodiments, the jackpot game operator can combine several jackpots associated with the same instant games, for example to provide several jackpots with different draw frequencies and amounts.

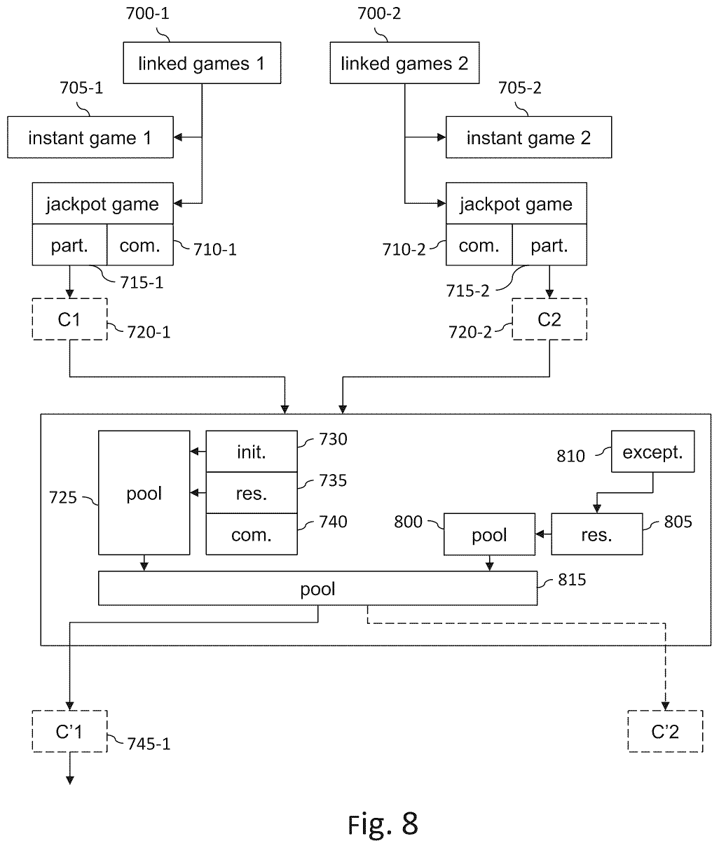

FIG. 8 illustrates a second example of implementation of two linked games comprising distinct instant games and a common jackpot game.

The example illustrated in FIG. 8 is based on the example of FIG. 7, with the same references designating the same elements. As illustrated in FIG. 8, part of the participation in the linked game sets is used to feed a second jackpot game pool, referenced 800, and to feed a reserve fund 805. The second pool can further be fed by the jackpot game operator from an exceptional fund 810. The pool 800 can then be added to the pool 725 to form the pool 815 being the subject of the jackpot.

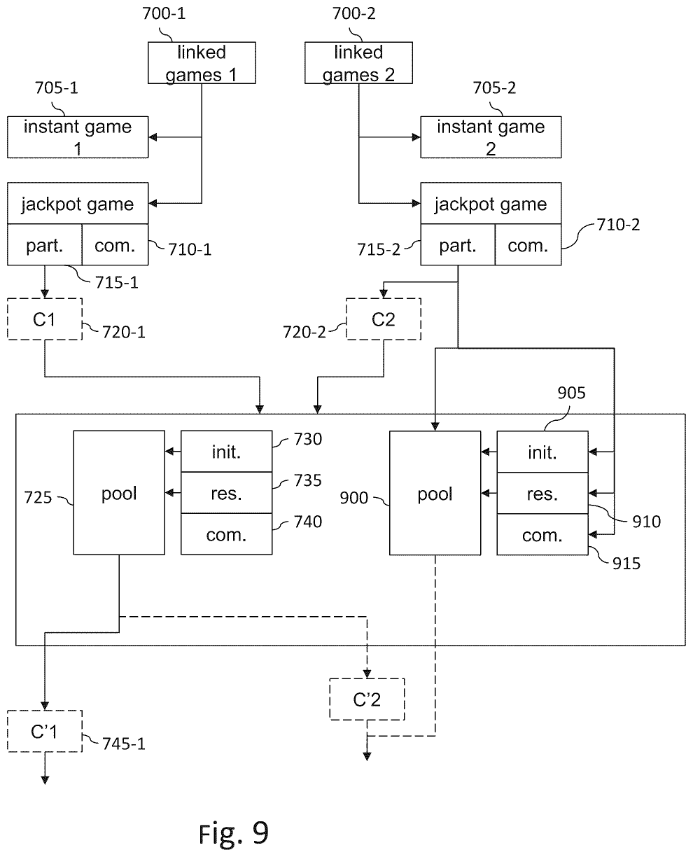

FIG. 9 illustrates a third example of implementation of two linked games comprising distinct instant games and a common jackpot game.

The example illustrated in FIG. 9 is based on the example of FIG. 7, with the same references designating the same elements. As illustrated in FIG. 9, part of the participation in the second set of linked games is used to feed a second jackpot game pool, referenced 900, to feed an initialization fund 905 and a reserve fund 910 specific to this second pool and to pay a commission 915 to the jackpot game operator. The second pool is specific to players participating in the linked games of the second set. According to the example illustrated, the second pool is managed in the currency of the games operator managing the second set of linked games. Alternatively, the second pool can be managed in game units or tokens.

According to the example illustrated in FIG. 9, a player participating in the first set of linked games participates in the pool 725 only, whereas a player participating in the second set of linked games participates in the pool 725 as well as the pool 900, these two pools preferably being the subject of different draws.

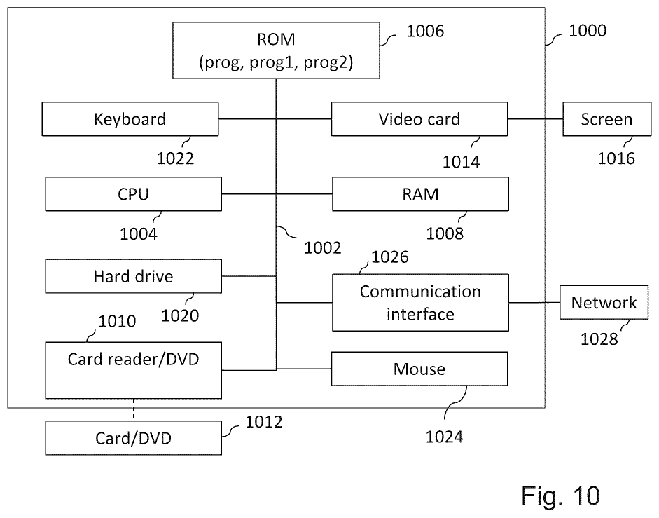

FIG. 10 illustrates an example of device that can be used to implement, at least partially, embodiments of the invention, in particular steps described with reference to FIGS. 2 to 9.

The device 1000 is for example a server, a computer or a terminal.

The device 1000 preferably includes a communication bus 1002 to which are connected:
a central processing unit 1004 (CPU);
a read only memory 1006 (ROM) that may include the operating system and programs such as “Prog”;
a random access memory 1008 (RAM) including registers adapted to save variables and parameters created and modified during the execution of the aforementioned programs; and
a communication interface 1026 connected to a distributed communication network 1028, for example a wireless communication network and/or a local communication network, the interface being capable of transmitting and receiving data, in particular to and from a device of a user.

Optionally, the device 1000 may also have the following elements:
a hard drive 1020 that may include the aforementioned programs “Prog” and data processed or to be processed according to the invention;
a keyboard 1022 and a mouse 1024 or any other pointing device such as an optical stylus, a touch screen or a remote control that makes it possible for the user to interact with the programs according to the invention;
a reader 1010 of a removable storage medium 1012 such as a memory card or a disc, DVD disc; and
a graphics card 1014 connected to a screen 1016.

The communication bus enables the communication and the interoperability between the various elements included in the device 1000 or connected to it. The representation of the bus is not limiting and, in particular, the central processing unit is likely to communicate instructions to any element of the device 1000 directly or by means of another element of the device 1000.

The executable code of each program making it possible for the programmable device to implement the processes according to the invention may be stored, for example, in the hard drive 1020 or in the read only memory 1006.

According to one alternative, the executable code of the programs may be received by means of the communication network 1028, via the interface 1026, to be stored in a manner identical to that described above.

More generally, the program(s) may be loaded into one of the storage means of the device 1000 before being executed.

The central processing unit 1004 will control and direct execution of the instructions or portions of software code of the program(s) according to the invention, instructions that are stored in the hard drive 1020 or in the read only memory 1006 or in the other aforementioned storage elements. When powering on, the program(s) that are stored in a non-volatile memory, for example the hard drive 1020 or the read only memory 1006, are transferred into the random access memory 1008 that then contains the executable code of the program(s) according to the invention, as well as registers for storing the variables and parameters necessary for implementing the invention.

Although embodiments of the invention have been explained in the context of games, it is not limited to this context.

Depending on the embodiment chosen, certain acts, actions, events or functions of each of the methods described in the present document may be carried out or occur according to an order different to that in which they have been described, or may be added, merged or even not be carried out or not occur, depending on the case. Furthermore, in certain embodiments, certain acts, actions or events are carried out or occur concurrently and not successively.

Although described through a number of detailed exemplary embodiments, the method provided and the equipment for implementing the method comprise different alternatives, modifications and improvements which will be obvious to those skilled in the art, it being understood that these different alternatives, modifications and improvements are within the scope of the invention. In addition, various aspects and features described above may be implemented together, or separately, or substitute one another, and all of the various combinations and sub-combinations of the aspects and features fall within the scope of the invention. Furthermore, it may be that some systems and equipment described above may not incorporate all of the modules and functions described for the preferred embodiments.

1. A digital linked games management method for a game system comprising a plurality of games devices and at least one server, wherein a first games device is configured to participate in a first and third game and a second games device is configured to participate in a second and third game, the first, second and third games being different, said at least one server comprising a first software module implementing said first game, a second software module implementing said second game and a third software module implementing said third game, said first, second and third software modules being distinct, said at least one server further comprising a linked game management software module, said linked game management software module being configured to execute said third software module following execution of said first software module and to execute said third software module following execution of said second software module, the method being implemented in said at least one server comprising at least one processor and comprising:
receiving, by said linked game management software module, digital data for executing said third game, said digital data being received from said first and second software modules, and
updating said third software module according to the digital data received.

2. The method according to claim 1, further comprising adapting at least one digital piece of data received according to a normalization coefficient linked to said first or second games device.

3. The method according to claim 2, wherein said adapting comprises converting said at least one piece of data received into a unit specific to said third software module.

4. The method according to claim 1, further comprising executing said third software module and generating a digital result.

5. The method according to claim 4, further comprising adapting said digital result according to an adaptation coefficient linked to said first or second games device.

6. The method according to claim 1, wherein received digital data are common data to users of said first and second software modules and received digital data are specific to users of said first software module or said second software module.

7. The method according to claim 6, wherein a generated result specific to a user of said first software module is based on said common data and on said data specific to said users of said first software module if there are data specific to said users of said first software module.

8. The method according to claim 4, further comprising transmitting said result to said first or second games device.

9. The method according to claim 1, wherein said first and second games are digital lottery games and said second game is a digital jackpot game.

10. A computer program embodied in a non-transitory computer readable storage medium and comprising instructions for implementing each of the steps of the method according to claim 1, when said program is executed by a processor.

11. A device comprising a processing unit configured to execute each of the steps of the method according to claim 1.

12. The method according to claim 5, further comprising transmitting said digital result to said first or second game device.

13. The method according to claim 6, further comprising executing said third software module and generating a digital result; and transmitting said digital result to said first or second game device.

14. The method according to claim 7, further comprising executing said third software module and generating a digital result; and transmitting said digital result to said first or second game device.
